(19) United States
(12) Patent Application Publication
(10) Pub. No.: US 2013/0332456 A1
(43) Pub. Date: Dec. 12, 2013

(54) METHOD AND SYSTEM FOR DETECTING OPERATING SYSTEMS RUNNING ON NODES IN COMMUNICATION NETWORK

(71) Applicant: Ofir Arkin, Petach Tikva (IL)

(72) Inventor: Ofir Arkin, Petach Tikva (IL)

(21) Appl. No.: 13/885,120

(22) PCT Filed: Nov. 10, 2011
(86) PCT No.: PCT/IL11/50008

§ 371 Date: Aug. 28, 2013

Related U.S. Application Data
(60) Provisional application No. 61/412,500, filed on Nov. 11, 2010.

(51) Int. Cl. G06F 17/30

(52) U.S. Cl. CPC G06F 17/30598
USPC 707/737

(57) ABSTRACT

Fingerprinting operating systems running on nodes in a communication network. Responsive to obtaining an event to be analyzed with respect to a given node, generating a group of two or more OS profiles matching the event; generating a sufficient set of one or more significant events, i.e. events obtained in order to identify, among the matching OS profiles in the generated group, the OS profile uniquely characterizing the OS running on the given node; upon obtaining a significant event from the given node, generating a new group of one or more matching OS profiles, wherein said new group is generated in accordance with said obtained significant event and at least, with one event previously analyzed with respect to the given node; and identifying the OS running on the given node with the help of said generated new group of one or more matching OS profiles.

### CROSS-REFERENCES TO RELATED APPLICATIONS

This application relates to and claims priority from U.S. Provisional Patent Application No. 61/412,500 filed on Nov. 11, 2010 incorporated herein by reference in its entirety. This application is a National Stage application from PCT application No. PCT/IL2011/050008 which is also hereby incorporated by reference in its entirety.

### FIELD OF THE DISCLOSURE

The present invention relates, m general, to the field of communication networks, and more specifically, to methods and systems capable of fingerprinting operating systems (OS) running on the nodes of a communication network.

### BACKGROUND

Operating system fingerprinting is the process enabling identification of operating systems of network nodes. Learning which operating system is running on a given network node can be very valuable for fixing vulnerabilities depending on the OS version, providing software remote upgrades, detecting unauthorized devices in a network, gathering OS deployment statistics, etc. By way of non-limiting example, fingerprinting can be done by analyzing different fields in data packets. Fingerprinting can be provided in an active mode comprising actively sending data packets to the network nodes and analyzing the responses, and/or in a passive mode comprising analyzing data packets passively received from the network nodes.

The problems of detecting an OS running on network nodes have been recognized in the contemporary art and various systems have been developed to provide a solution, for example:

international Patent Application No. WO2005/053230 entitled “Method and system for collecting information relating to a communication network” discloses a method and a system wherein data conveyed by nodes operating in a communication network is detected in a manner that is transparent to the nodes. The detected data is analyzed for identifying information relating to the communication network and for identifying missing information. In order to complete the missing information, one or more of the nodes are queried.

US Patent Application No. 2009/037353 entitled “Method and system for evaluating tests used in operating system fingerprinting” discloses a system for evaluating classification systems such as an operating system (OS) fingerprinting tool (e.g., Nmap); information gain is used as a metric to evaluate the quality of the tool's classification tests, including fingerprinting tests and their associated probes. Information gain is determined using the OS fingerprinting tool's signature database rather than raw training samples, including taking into account signatures/data that are represented by ranges of test values, disjunctive values, and missing values. Uniform distributions over test values and classifications are assumed in applying these methods to an example signature database for Nmap. Other assumptions or a priori information (e.g., normal distributions over ranges) can also be accommodated.

US Patent application No. 2009/182864 entitled “Method and apparatus for fingerprinting systems and operating systems in a network” discloses a system and method for identifying the number of computer hosts and types of operating systems behind a network address translation. The method includes processing an Internet protocol packet associated with the host computer system. The process may involve capturing the Internet protocol packet and extracting key fields from the Internet protocol packet to produce a fingerprint. The method continues with analyzing the fields in order to determine if a network address translator is connected between the host computer and a public network (e.g. the Internet). If there is a network address translator connected, fields may be analyzed in order to determine the number of computers using the network address translator. The fields may also be analyzing in order to determine, with a level of probability, that the fingerprint identities the correct operating system running the host computers. Generally, the Internet protocol packet that is analyzing will be captured from an aggregation point in the carrier network.

US Patent Application 2010/185759 entitled “Method and apparatus for Layer 2 discovery in a managed shared network” discloses a method and apparatus wherein a node on a network submits to a network controller a request for discovery of information regarding communication capabilities of other network nodes. The network controller sends a request for node communication capabilities to the other nodes in the network; receives responses from the other nodes that include information regarding communication capabilities of each respective node; and send the received information regarding communication capabilities of the nodes to a plurality of nodes in the network.

United States Patent Publication No. 2002/032754 entitled “Method and apparatus for profiling in a distributed application environment” discloses a method and apparatus for deriving and characterizing the resource capabilities of client devices in a distributed application (DA) network environment. A method and associated architecture for obtaining client device configuration and resource information incorporate a distributed profiling entity having a server portion and client portion, the client portion being used to facilitate query of the client device, and transfer of device resource and configuration information back to the server portion. This information is later used by the profiling entity to alter and update the distribution of entity components between the server and client device. The client device configuration may also be altered if required. In a second aspect of the invention, a method of scaling the aforementioned distributed profiling entity during both initial download and after initiation is disclosed.

The article “The Present and Future of Xprobe2, the Next Generation of Active Operating System Fingerprinting” (Ofir Arkin et al., published on the Internet in July 2003, see http://www.netsecurity.org/dl/articles/Present_and_Future_Xprobe2-vl.O.pdf describes a system performing active operating system fingerprinting. According to The Present and Future of Xprobe2, active operating system fingerprinting is the process of actively determining a targeted network node's underlying operating system by probing the targeted system with several packets and examining the response(s) received.

### SUMMARY

In accordance with certain aspects of the presently disclosed subject matter, there is provided a method of detecting an operating system (OS) running on a node in a communication network. The method comprises: (a) responsive to obtaining an event to be analyzed with respect to a given node, generating a group of two or more OS profiles matching the event; (b) generating a sufficient set of one or more events to be obtained in order to identify, among the matching OS profiles in the generated group, the OS profile uniquely characterizing the OS running on the given node, to yield the sufficient set of significant events; (c) upon obtaining a significant event with respect to the given node, generating a new group of one or more matching OS profiles, wherein said new group is generated in accordance with said obtained significant event and at least, with one event previously analyzed with respect to the given node; and (d) identifying the OS running on the given node with the help of said generated new group of one or more matching OS profiles.

When the generated new group of matching OS profiles comprises a single OS profile, the method further comprises identifying the OS running on the given node as corresponding to said single profile. When said generated new group of matching OS profiles comprises two or more matching OS profile, the method further comprises repeating operations b) and c) until generating a new group of matching OS profiles with a single OS profile, and identifying the OS running on the given node as corresponding to said single profile. The operations b) and c) can be discontinued before identifying the OS running on the given node if a certain significant event has not been obtained during a predefined time. Alternatively or additionally, the method can further comprise re-generating a sufficient set of significant events if a certain active significant event has not been obtained during a predefined time, whilst excluding said non-obtained significant event from the re-generated sufficient set of significant events.

In accordance with other aspects of the presently disclosed subject matter, there is provided an OS detector operable to detect an operating system (OS) running on a node in a communication network. The OS detector comprises: an OS profiles database accommodating OS profiles characterizing respective operating systems; an events interface configured to obtain events in a passive and/or in an active mode; and an analyzing and managing unit (A&M unit) operatively coupled to the OS database and to the events interface, and the A&M unit operable: (a) responsive to obtaining an event to be analyzed with respect to a given node, to generate a group of two or more OS profiles matching the event; (b) to generate a sufficient set of one or more events to be obtained in order to identify, among the matching OS profiles in the generated group, the OS profile uniquely characterizing the OS running on the given node, to yield the sufficient set of significant events; (c) upon obtaining a significant event with respect to the given node, to generate a new group of one or more matching OS profiles, wherein said new group is generated in accordance with said obtained significant event and, at least, with one event previously analyzed with respect to the given node; and (d) to identify the OS running on the given node with the help of said generated new group of one or more matching OS profiles.

When said generated new group of matching OS profiles comprises a single OS profile, the A&M unit is further operable to identify the OS running on the given node as corresponding to said single profile. When said generated new group of matching OS profiles comprises two or more matching OS profile, the A&M unit is further operable to repeat operations h) and c) until generating a new group of matching OS profiles with a single OS profile, and to identify the OS running on the given node as corresponding to said single profile. The A&M unit can be configured to terminate operations b) and c) before identifying the OS running on the given node if a certain significant event has not been obtained during a predefined time. Alternatively or additionally, the A&M unit can be further configured to re-generate a sufficient set of significant events if a certain active significant event has not been obtained during a predefined time, whilst excluding said non-obtained significant event from the re-generated sufficient set of significant events.

Further aspects are related to the disclosed method and/or to the disclosed OS detector.

In accordance with further aspects and in combination with other aspects of the presently disclosed subject matter, a generated sufficient set of significant events can constitute or cannot constitute a subset of a previously generated sufficient set of significant events. The sufficient set of significant events can comprise one or more passive and/or one or more active significant events. Optionally, the sufficient set of significant events can comprise at least two alternative significant events. The generated sufficient set of significant events can be optimized in accordance with predefined criteria (e.g. related to a minimal number of events to be obtained and/or minimal number of certain type of events to be obtained and/or minimal time of OS detecting process).

In accordance with further aspects and in combination with other aspects of the presently disclosed subject of previous, a new group of matching OS profiles can be generated by comparing properties corresponding to the obtained significant event with OS profiles comprised in a previously generated group of matching OS profiles. A generated new group of matching OS profiles can comprise all or a part of OS profiles matching the obtained significant event and, at least, one event previously analyzed with respect to the given node. Optionally, a generated new group of matching OS profiles can comprise all or a part of OS profiles matching the obtained significant event and all events previously analyzed with respect to the given node.

Among advantages of certain embodiments of the disclosed subject matter is a capability to minimize the amount of events necessary to be obtained for fingerprinting the OSs running on network nodes. Among further advantages of certain embodiments of the disclosed subject matter is a capability to minimize the processing time for executing the identification process.

### BRIEF DESCRIPTION OF THE DRAWINGS

In order to understand the invention and to see how it can be carried out in practice, embodiments will now be described, by way of non-limiting example only, with reference to the accompanying drawings, in which:

FIG. 1 illustrates a schematic diagram of communication network architecture applicable to certain embodiments of the presently disclosed subject matter.

FIG. 2 illustrates a generalized functional block diagram of an OS detector in accordance with certain embodiments of the presently disclosed subject matter; and

FIG. 3 illustrates a generalized flow-chart of an OS fingerprinting process in accordance with certain embodiments of the presently disclosed subject matter.

### DETAILED DESCRIPTION OF EMBODIMENTS

In the following detailed description, numerous specific details are set forth in order to provide a thorough understanding of the invention. However, it will be understood by those skilled in the art that the presently disclosed subject matter can be practiced without these specific details. In other instances, well-known methods, procedures, components and circuits have not been described in detail so as not to obscure the presently disclosed subject matter. In the drawings and descriptions, identical reference numerals indicate those components that are common to different embodiments or configurations.

Unless specifically stated otherwise, as apparent from the following discussions, it is appreciated that throughout the specification discussions utilizing terms such as “processing”, “calculating”, “determining”, “generating”, “receiving”, “obtaining”, “classifying”, “comparing” or the like, refer to the action and/or processes of a computer that manipulate and/or transform data into other data, said data represented as physical, such as electronic, quantities and/or said data representing the physical objects. The term “computer” should be expansively construed to cover any kind of electronic system with data processing capabilities.

The operations in accordance with the teachings herein can be performed by a computer specially constructed for the desired purposes or by a general-purpose computer specially configured for the desired purpose by a computer program stored in a non-transitory computer readable storage medium.

Embodiments of the presently disclosed subject matter are not described with reference to any particular programming language. It will be appreciated that a variety of programming languages can be used to implement the teachings of the inventions as described herein.

The references cited in the background teach many principles of OS detection that are applicable to the presently disclosed subject matter. Therefore, the full contents of these publications are incorporated by reference herein for appropriate teachings of additional or alternative details, features and/or technical background.

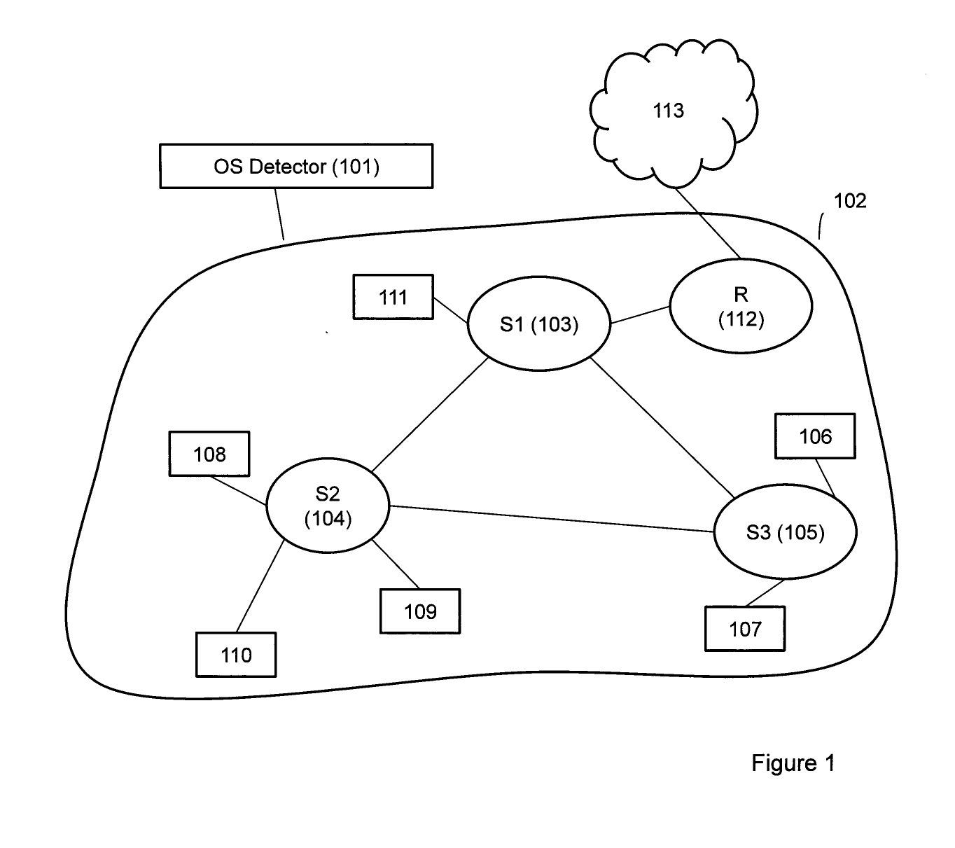

Bearing this in mind, attention is drawn to FIG. 1 illustrating a schematic diagram of communication network architecture applicable to certain embodiments of the presently disclosed subject matter. The term “communication network” used in this patent specification should be expansively construed to cover any kind of network constituted by a collection of nodes and links there between arranged so that communication objects (e.g. data, voice, video, messages, etc) be passed from one node to another, optionally over multiple links and through various nodes. Non-limiting examples of communication networks are computer networks, telecommunication networks, storage networks, etc. Optionally, a communication network can comprise several physical or virtual sub-networks interconnected there between.

As illustrated by way of non-limiting example, a system for fingerprinting operating systems (referred to hereinafter as an OS detector) 101 is operatively coupled to a communication network 102 comprising three switches 103, 104 and 105. Terminal nodes 106 and 107 are coupled to the switch 105, terminal nodes 108, 109 and 110 are coupled to the switch 104, and terminal node 111 is coupled to the switch 103. The switch 103 is coupled also to a router 112 connecting the network 102 and the nodes being part thereof to the Internet 114. Thus, the illustrated network 102 comprises switches 103, 104, 105, terminal nodes 106-111 and router 112.

For purpose of illustration only, the following description is provided for the OS detector configured as an external entity with respect to the communication network 102. Those skilled in the art will readily appreciate that the teachings of the presently disclosed subject matter are applicable in a similar manner to the OS detector configured as a separate node within the communication network 102 or configured as fully or partly integrated with one or more nodes of the communication network 102.

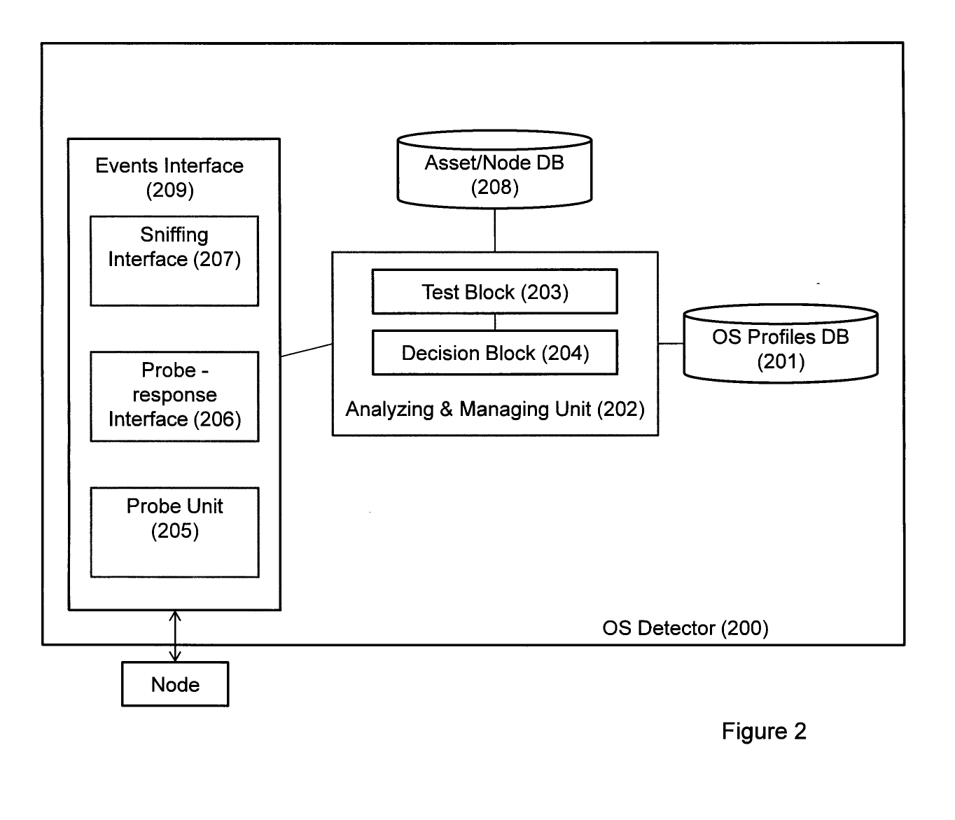

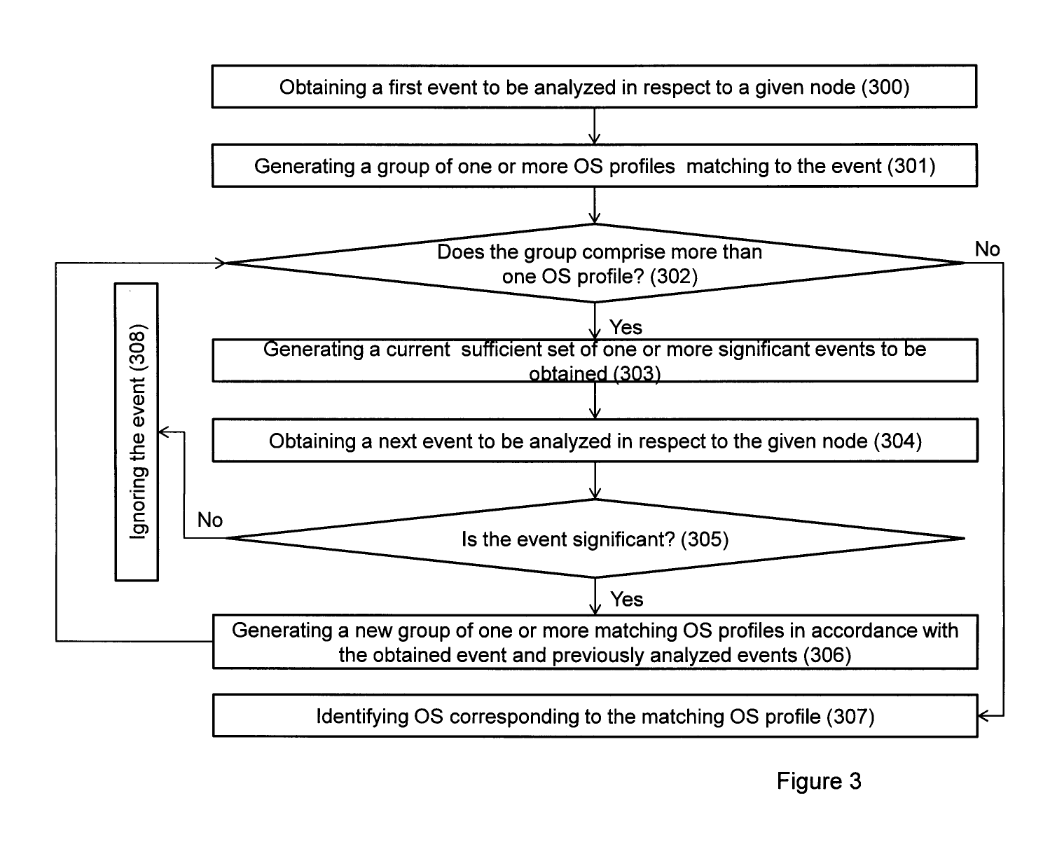

As will be further detailed with reference to FIGS. 2-3, in accordance with certain embodiments of the presently disclosed subject matter, the OS detector 101 is configured to identify the operating systems of the nodes in the network 102.

The fingerprinting process of determining the operating system of a given node is based on comparing properties of observed data packets related to the given node with pre-defined properties characterizing certain OSs. By way of non-limiting example, fingerprinting can be provided based on TCP/IP stack fingerprinting, application level fingerprinting and/or comparing other properties inferred from the observed data packets.

As will be detailed with reference to FIG. 2, data packets can be received in an active mode and/or in a passive mode. In active mode, the OS detector sends specifically configured data packets (“probes”) to the given node and analyses the packets returned in response, if any. In passive mode, the OS detector receives data packets by sniffing communication between the given node and other nodes within and/or outside the network, and analyses these packets. To classify the operating system of the given node, the properties of analyzed data packets are compared to the respective properties characterizing known operating systems.

Note that the invention is not bound by the specific architecture of the communication network described with reference to FIG. 1. Those versed in the art will readily appreciate that the invention is likewise, applicable to any communication network and/or parts thereof comprising nodes capable to convey required data to the OS detector.

Referring to FIG. 2, there is illustrated a generalized functional block diagram of an OS detector in accordance with certain embodiments of the presently disclosed subject matter.

The OS detector 200 comprises a database 201 of OSs profiles. The term “OS profile of a given OS” should be expansively construed to cover a unique set of properties of data packets, said properties characterizing the given OS, useful for its identification and referred to hereinafter as OS signatures. Some signatures can be common for two or more operating systems, while each set of signatures (i.e. OS profile) is unique for respective operating systems. In certain embodiments, the OS profile can be common to a group of operating systems; such operating systems can be fingerprinted only on the group level. Referring hereinafter to “operating system” includes, also, referring to such a group of operating systems characterized by the same OS profile. The OS fingerprinting process is based on comparing properties of observed data packets related to the given node with signatures comprised in the database 201 and corresponding to one or more OS profiles.

The OS profiles database 201 is operatively coupled to an analyzing and managing unit 202, which is operatively coupled to an events interface 209 comprising probe unit 205, a probe-response interface 206 and a sniffing interface 207.

The OS detector is configured to obtain data packets in a passive mode and/or in an active mode. In active mode, the OS detector is configured to obtain data packets via the probe-response interface 206 in response to the probes generated and sent by the probe unit 205; packets in the passive mode are obtained via the sniffing interface 207.

A passively obtained data packet or series of data packets usable for OS fingerprinting are referred to hereinafter as a passive event eₚ. An actively obtained data packet or series of data packets usable for OS fingerprinting are referred to hereinafter as an active event eₐ, examples of events includes series of data packets related to SYN REQUEST, SYN-ACK response, DHCP DISCOVERY, DHCP REQUEST, HTTP REQUEST, etc. Such events can be related to TCPIIP stack based OS fingerprinting, application-based fingerprinting, etc. By way of non-limiting example, active fingerprinting can be provided with “Nmap,” “synscan” and/or “Xprobe2” tools, and passive fingerprinting can be provided with “p0f” and/or “SinFP” tools.

The passive events obtained via the interface 207 and/or active events obtained via the interface 208 are forwarded to the analyzing and managing (A&M) unit 202.

The A&M unit is further operatively coupled to an asset/node database 208 configured to accommodate events related to a given node. By way of non-limiting example, the database 208 can maintain for each node a list of events (and/or derivatives thereof) related to the node. The list is maintained, at least, until the OS running on the given node is identified. Optionally, the list can be maintained throughout the time a node is attached to the network (i.e. from the time it is powered on and is connected to the network until it is disconnected/goes offline), thus enabling monitoring of OS updates (if any). Optionally, the list can be maintained when a node is in offline mode (not connected to the network after previously being connected), thus enabling monitoring of OS updates (if any). The list can include all events related to the nodes or only events analyzed during the fingerprinting process.

The A&M unit 202 comprises a test block 203 operatively coupled to a decision block 204. The test block 203 is configured to infer the properties of the obtained events. The test block 203 is further configured to compare the inferred properties with the signatures accommodated in the OS profiles database 201 and to identify one or more OS profiles matching the inferred properties. Upon analyzing an event e related to a given node, the test block identifies one or more matching OS profiles P₁ and generates a group P of OS profiles matching the event. The matching is provided in view of previously analyzed events (if any) related to the given node. The group P of matching OS profiles comprises OS profiles matching all analyzed events related to the given node:

e₁ [symbol] e₂ [symbol] . . . [symbol] eₙ→ [symbol] P₂ [symbol] . . . [symbol] Pₙ

If the generated group of matching OS profiles comprises a single matching OS profile (P={Pₓ}), this single matching profile characterizes the operating system running on the respective node, and such a given event is referred to hereinafter as a sufficient event.

If the generated group of matching OS profiles comprises a plurality of matching OS profiles (P={P₁, P₂ . . . Pₙ}), such a given event is referred to hereinafter as an insufficient event.

The group of matching OS profiles generated for a given node is stored in the database 208.

The decision block 204 is configured to analyze the generated group of multiple matching OS profiles and to generate a set of one or more events to be further analyzed, such a set enabling selecting among the multiple matching OS profiles the unique OS profile corresponding to the OS running on the respective node. Such a generated set is referred to hereinafter as a sufficient set, and the events in the sufficient set are referred to hereinafter as significant events. At least part of significant events in the sufficient set can be alternative events, i.e. upon obtaining any one of such events, the event(s) alternative to the obtained event cease to be significant.

The decision block can generate the sufficient set by processing all of the possible optional combination of events, either with the help of a generated m advance state machine, or with the help of any other appropriate technique.

The decision block is further configured to instruct the probe unit 205 to generate a respective probe and to send it the given node in case the sufficient set comprises one or more active events.

The A&M unit is further configured to enable storing and updating in the database 208 respectively generated sufficient sets per each node of interest.

The decision block can be configured to generate the sufficient set responsive to results of analyses provided, merely, with respect to significant events. Additionally or alternatively, the decision block can be configured, upon generating the sufficient set, to update the test block about events defined as currently significant; and the test block can be configured to provide the further analyses responsive, merely, to the significant events.

By way of non-limiting example, the sufficient set can be configured as a decision matrix comprising one or inure passive events to be obtained and/or one or more active events to be obtained.

Optionally, the decision block can be further configured to optimize the generated sufficient set in accordance with predefined criteria (e.g. minimal number of events to be obtained and/or minimal number of certain type of events to be obtained and/or minimal time of OS fingerprinting process, etc.).

In certain cases (e.g. if a node is filtered and/or firewalled), the probes can fail to cause the respective significant active events. In such cases, the OS detector can be configured to provide partial results (e.g. a group of OSs corresponding to the previously generated group of matching OS profiles) and/or to stop the fingerprinting process for the node. Alternatively, the OS detector can be configured to re-generate (e.g. upon end of predefined response waiting time) the sufficient set eliminating certain or all active events, if possible.

The OS detector can be further configured to stop the fingerprinting process for a given node if it finds out that the database 201 does not comprise an OS profile characterizing the OS running on the node.

The OS detector can be further configured to receive information related to newly attached nodes to the network, and to initiate OS fingerprinting accordingly. By way of non-limiting example, the information related to newly added nodes can be received in a manner disclosed in International Application No. WO 2005/053230 assigned to the assignee of the present application and incorporated hereto by reference in its entirety.

Those versed in the art will readily appreciate that the embodiments of the invention are not bound by the specific architecture described with reference to FIG. 2; equivalent and/or modified functionality can be consolidated or divided in another manner and can be implemented in any appropriate combination of software, firmware and hardware. In different embodiments of the presently disclosed subject matter, operative connections between the blocks and/or within the blocks can be implemented directly (e.g. via a bus) or indirectly, including remote connection.

Referring to FIG. 3, there is illustrated a generalized flow-chart of OS fingerprinting for a given node in accordance with certain embodiments of the presently disclosed subject matter. Upon obtaining (300) a first event to be analyzed for fingerprinting with respect to the given node, the OS detector analyzes the event and generates (301) a group of one or more OS profiles matching the event. If the group comprises a single OS profile, this OS profile uniquely characterizes the OS running on the given node (307). If the group comprises (302) a plurality of OS profiles, the OS detector generates (303) a current sufficient set of one or more significant events, i.e. events to be obtained in order to identify, among the matching OS profiles, the OS profile uniquely characterizing the OS running on the given node. Upon obtaining (304) a next event, passive or active, to be analyzed for fingerprinting with respect to the given node, the OS detector checks (305) if the event is significant and generates (306) a new group of matching OS profiles in accordance with the obtained significant event and previously analyzed events.

The new group of matching OS profiles can be generated by comparing the properties corresponding to the obtained next event with signatures in OS profiles comprised in a previously generated group of matching OS profiles. Alternatively, the new group can be generated by analyzing all OS profiles comprised in database 201. In case the previously generated group of matching OS profiles does not comprise all OS profiles matching the previous events only several most likely OS profiles), the group generating process can start with analyses of matching OS profiles defined at a previous cycle, and, if necessary, continue by analyzing all OS profiles.

The OS detector further repeats the operations 302-306 for each newly generated group of matching OS profiles until generating the group with a single matching OS profile and, thus, identifying the OS running on the given node, Operations 302-306 can be stopped before identifying the respective OS in cases of missing a OS profile corresponding to the observed data packets, or of missing a response to the generated probe, etc.

The sufficient set of significant events is dynamic. The number of events (excluding alternative exents) shrinks with each next cycle of operations 302-306, while the significant events at each next cycle do not necessarily constitute a subset of events at a previous cycle. The group of matching OS profiles at each next cycle constitutes a subset of the group of matching OS profiles at previous cycles.

Optionally, the OS detector can be configured to generate (306) the new group of matching OS profiles responsive to any obtained event or responsive to certain (not necessary significant) predefined event(s) to be analyzed, while generating anew sufficient set of significant events, merely responsive to obtaining a significant event.

Non-significant events can be ignored (308) and, optionally, further recorded in the database 208.

The OS detector can be further configured to monitor deviations in inferred properties of repeating events related to a given node, such deviations indicative of changes related to the OS running on the node. The OS detector can be configured to initiate the fingerprinting process for the given node upon detecting such a deviation, and/or provide an appropriate alert. This allows identifying any changes with respect to the underlying running operating system of a node (i.e. machine dual boot, virtualization, spoofing, etc.), identifying a NAT-enabled device, etc.

By way of non-limiting example, for a certain node, the obtained NetBIOS data packet can be a first event to be analyzed. The respectively generated group of matching OS profiles can comprise OS profiles of Microsoft Windows 7, Microsoft Windows 2008 and Microsoft Windows Vista. The generated sufficient not of significant events can comprise a single significant event, namely, a response to a SMB query. Accordingly, obtaining a response to the SMB query enables fingerprinting the underlying OS running on the node among Microsoft Windows 7, Microsoft Windows 2008 and Microsoft Windows Vista.

By way of another non-limiting example for a certain node, an obtained SYN-ACK event can be a first event to be analyzed. The respectively generated group of matching OS profiles can comprise Microsoft Windows XP and Microsoft Windows 2003. The generated sufficient set of significant events can comprise alternative events, namely a passive event of a HTTP Request and a passive event of NetBIOS. Analyses of packets corresponding to any one of the alternative events enables identifying the OS running on the node (i.e. Microsoft Windows XP or Microsoft Windows 2003).

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based can readily be utilized as a basis for designing other structures, methods, and systems for carrying out the several purposes of the present invention.

It will also be understood that the apparatus according to the invention can be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

Those skilled in the art will readily appreciate that various modifications and changes can be applied to the embodiments of the invention as hereinbefore described without departing front its scope, defined in and by the claims associated with the present invention.

1. A method of detecting an operating system (OS) running on a node in a communication network, the method comprising:
(a) responsive to obtaining an event to be analyzed with respect to a given node, generating a group of two or more OS profiles matching the event;
(b) generating a sufficient set of one or more events to be obtained in order to identify, among the matching OS profiles in the generated group, the OS profile uniquely characterizing the OS running on the given node, to yield the sufficient set of significant events;
(c) upon obtaining a significant event with respect to the given node, generating a new group of one or more matching OS profiles, wherein said new group is generated in accordance with said obtained significant event and at least, with one event previously analyzed with respect to the given node; and
(d) identifying the OS running on the given node with the help of said generated new group of one or more matching OS profiles.

2. The method of claim 1 wherein said generated new group of matching OS profiles comprises a single OS profile, the method further comprising identifying the OS running on the given node as corresponding to said single profile.

3. The method of claim 1 wherein said generated new group of matching OS profiles comprises two or more matching OS profile, the method further comprising: repeating operations b) and c) until generating a new group of matching OS profiles with a single OS profile, and identifying the OS running on the given node as corresponding to said single profile.

4. The method of claim 3 wherein a generated sufficient set of significant events does not constitute a subset of a previously generated sufficient set of significant events.

5. The method of claim 3 wherein a generated sufficient set of significant events constitutes a subset of a previously generated sufficient set of significant events.

6. The method of any one of claims 1-5, wherein the significant event is a passive event.

7. The method of any one of claims 1-6, wherein the significant event is an active event.

8. The method of any one of claims 1-7, wherein the sufficient set of significant events comprises at least two alternative significant events.

9. The method of any one of claims 1-8 wherein a new group of matching OS profiles is generated by comparing properties corresponding to the obtained significant event with OS profiles comprised in a previously generated group of matching OS profiles.

10. The method of any one of claims 1-9 wherein a generated new group of matching OS profiles comprises OS profiles matching the obtained significant event and all events previously analyzed with respect to the given node.

11. The method of any one of claims 1-10 wherein a generated new group of matching OS profiles comprises all OS profiles matching the obtained significant event and all events previously analyzed with respect to the given node.

12. The method of any one of claims 1-11 wherein a generated new group of matching OS profiles comprises a part of OS profiles matching the obtained significant event and, at least, one event previously analyzed with respect to the given node.

13. The method of claim 12 further comprising comparing properties corresponding to the obtained significant event with OS profiles comprised in a database of OS profiles if the generated new group of matching OS profiles does not comprise an OS profile matching the obtained significant event.

14. The method of any one of claims 1-13 wherein the generated sufficient set of significant events is optimized in accordance with predefined criteria.

15. The method of claim 14 wherein the predefined criteria is related to a minimal number of events to be obtained and/or minimal number of certain type of events to be obtained and/or minimal time of OS detecting process.

16. The method of any one of claims 1-15, wherein a generated new group of matching OS profiles comprises two or more matching OS profile, the method further comprising discontinuing operations b) and c) before identifying the OS running on the given node if a certain significant event has not been obtained during a predefined time.

17. The method of any one of claims 1-15 further comprising re-generating a sufficient set of significant events if a certain active significant event has not been obtained during a predefined time, whilst excluding said non-obtained significant event from the re-generated sufficient set of significant events.

18. The method of any one of claims 1-17, further comprising:
(a) monitoring events related to a given node and detecting deviations in inferred properties of repeating events related to the given node; and
(b) initiating OS detecting for the given node upon detecting a pre-defined deviation.

19. An OS detector operable to detect an operating system (OS) running on a node in a communication network, the OS detector comprises:
an OS profiles database accommodating OS profiles characterizing respective operating systems;
an events interface configured to obtain events in a passive and/or in an active mode; and
an analyzing and managing unit (A&M unit) operatively coupled to the OS database and to the events interface, the A&M unit operable:
(a) responsive to obtaining an event to be analyzed with respect to a given node, to generate a group of two or more OS profiles matching the event;
(b) to generate a sufficient set of one or more events to be obtained in order to identify, among the matching OS profiles in the generated group, the OS profile uniquely characterizing the OS running on the given node, to yield the sufficient set of significant events;
(c) upon obtaining a significant event with respect to the given node, to generate a new group of one or more matching OS profiles, wherein said new group is generated in accordance with said obtained significant event and, at least, with one event previously analyzed with respect to the given node; and
(d) to identify the OS running on the given node with the help of said generated new group of one or more matching OS profiles.

20. The OS detector of claim 19 wherein said generated new group of matching OS profiles comprises a single OS profile, and wherein the A&M unit is further operable to identify the OS running on the given node as corresponding to said single profile.

21. The OS detector of claim 19 wherein said generated new group of matching OS profiles comprises two or more matching OS profile, and wherein the A&M unit further operable to: repeat operations b) and c) until generating a new group of matching OS profiles with a single OS profile, and to identify the OS running on the given node as corresponding to said single profile.

22. The OS detector of any one of claims 19-21, wherein the significant event is a passive event received by sniffing provided with the help of the events interface.

23. The OS detector of any one of claims 19-22, wherein the significant event is an active event obtained in response to a probe generated and sent with the help of the events interface in accordance with in instructions received from the A&M unit.

24. The OS detector of any one of claims 19-23, wherein the sufficient set of significant events comprises at least two alternative significant events.

25. The OS detector of any one of claims 19-24 wherein the A&M unit is operable to generate a new group of matching OS profiles by comparing properties corresponding to the obtained significant event with OS profiles comprised in a previously generated group of matching OS profiles.

26. The OS detector of any one of claims 19-25 wherein a generated new group of matching OS profiles comprises OS profiles matching the obtained significant event and all events previously analyzed with respect to the given node.

27. The OS detector of any one of claims 19-26 wherein a generated new group of matching OS profiles comprises all OS profiles matching the obtained significant event and all events previously analyzed with respect to the given node.

28. The OS detector of any one of claims 19-25 wherein a generated new group of matching OS profiles comprises a part of OS profiles matching the obtained significant event and, at least, one event previously analyzed with respect to the given node.

29. The OS detector of claim 28, wherein the A&M unit is further operable to compare properties corresponding to the obtained significant event with OS profiles comprised in the OS profiles database if the generated new group of matching OS profiles does not comprise an OS profile matching the obtained significant event.

30. The OS detector of any one of claims 19-28, wherein the A&M unit is further operable to optimized the sufficient set of significant events in accordance with predefined criteria.

31. The OS detector of claim 30 wherein the predefined criteria is related to a minimal number of events to be obtained and/or minimal number of certain type of events to be obtained and/or minimal time of OS detecting process.

32. The OS detector of any one of claims 19-31, wherein the A&M unit is further operable to re-generate a sufficient set of significant events if during a predefined time a certain active significant events has not been obtained, wherein said non-obtained significant event is excluded from the re-generated sufficient set of significant events.

33. The OS detector of any one of claims 19-32 further comprising a nodes database operatively coupled to the A&M unit, wherein the nodes database is operable to accommodate events related to one or more given nodes.

34. The OS detector of claim 33 wherein the nodes database is operable to maintain for each given node a list of events and/or derivatives thereof related to the respective node, and wherein said list comprises, at least, events which have been analyzed with respect to the respective node.

35. The OS detector of any one of claims 19-34 wherein the A&M unit is operable to generate the sufficient set in a form of a decision matrix comprising one or more passive events to be obtained and/or one or more active events to be obtained.

36. The OS detector of any one of claims 19-35 further operable:
(a) to monitor events related to a given node and to detect deviations in inferred properties of repeating events related to the given node; and
(b) to initiate OS detecting for the given node upon detecting a pre-defined deviation.

37. The OS detector of any one of claims 19-35 further operable to initiate, upon obtaining information related to a node newly attached to the network, OS detecting for said new node.

38. A computer program comprising computer program code means for performing all the stages of any one of claims 1-18 when said program is run on a computer.

39. A computer program as claimed in claim 38 embodied on a computer readable medium.
